(19) United States
(12) Patent Application Publication
(10) Pub. No.: US 2016/0012537 A1
(43) Pub. Date: Jan. 14, 2016

(54) AUTOMATED TRANSFORMATION OF OBJECT IDENTIFICATION INTO EXECUTABLE INVESTMENT

(71) Applicant: Albert Charles Hardin, Euclid, OH (US)

(72) Inventor: Albert Charles Hardin, Euclid, OH (US)

(21) Appl. No.: 14/796,277

(22) Filed: Jul. 10, 2015

Related U.S. Application Data
(60) Provisional application No. 61/998,902, filed on Jul. 11, 2014.

(51) Int. Cl. G06Q 40/06; G06F 3/0485; G06F 3/0482; G06F 3/0484; G06Q 40/04; G06F 3/0481

(52) U.S. Cl. CPC G06Q 40/06; G06Q 40/04; G06F 3/04817; G06F 3/0482; G06F 3/04842; G06F 3/0485

(57) ABSTRACT

Aspects provide for the automatic identification and execution of investment opportunities in entities associated with graphic image subject matter. In response to user selection of graphic elements displayed within a graphical user interface display, a corporate entity is identified that is associated with the graphic element and with an opportunity for investment by the user in the corporate entity, and an associated selectable investment icon is generated and displayed. Selection of the selectable investment icon by the user, displays a selectable investment execution graphic element describing investment offer conditions for the associated corporate entity. Selection of the selectable investment icon automatically executes the offer for investment in the associated corporate entity pursuant to the described conditions, thereby acquiring an investment in the corporate entity for the user.

### BACKGROUND

A wide variety of investment vehicles enable a user to invest in publicly traded stocks and mutual funds. Choices made tend to be driven by knowledge of pricings and offerings categorized at a general, industry level, and only indirectly via relationship to given products known from a consumer perspective.

Direct consumer investing choices tend to be driven by analysis and recommendations provided by broker services, participation in stock indexes and the holdings of mutual funds, and personal awareness of goods and services created by news stories, advertising, personal consumer behavior and the like. Without expending large amounts of time and effort in research, including via arcane and hard to find sources, individual miss opportunities to identify and trade in investments in the many lesser-known companies that participate (profitably) in the same business activities with the larger, well-known and brand name entities, wherein stocks shares may be acquired generally at a lower trading price in said smaller participating entities, thus offering better profit opportunities associated with the same endeavor.

### BRIEF SUMMARY

Aspects provide for the automatic identification and execution of investment opportunities in entities associated with graphic image subject matter. In response to user selection of graphic elements displayed within a graphical user interface display, a corporate entity is identified that is associated with the graphic element and with an opportunity for investment by the user in the corporate entity, and an associated selectable investment icon is generated and displayed. Selection of the selectable investment icon by the user, displays a selectable investment execution graphic element describing investment offer conditions for the associated corporate entity. Selection of the selectable investment icon automatically executes the offer for investment in the associated corporate entity pursuant to the described conditions, thereby acquiring an investment in the corporate entity for the user.

In one aspect of the present invention, a method for the automatic identification and execution of investment opportunities in entities associated with graphic image subject matter is provided, as described above and by the claims and by the embodiments of FIGS. 1-4 described below.

In another aspect, a system has a hardware processor in circuit communication with a computer readable memory and a computer-readable storage medium having program instructions stored thereon. The processor executes the program instructions stored on the computer-readable storage medium via the computer readable memory and thereby provides for the automatic identification and execution of investment opportunities in entities associated with graphic image subject matter is provided, as described above and by the claims and by the embodiments of FIGS. 1-4 described below.

In another aspect, a computer program product for the automatic identification and execution of investment opportunities in entities associated with graphic image subject matter has a computer-readable hardware storage device with computer readable program code embodied therewith. The computer readable program code includes instructions for execution which cause a processor to provide for the automatic identification and execution of investment opportunities in entities associated with graphic image subject matter is provided, as described above and by the claims and by the embodiments of FIGS. 1-4 described below.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a method or process aspect according to the present invention for the automatic identification and execution of investment opportunities in entities associated with graphic image subject matter.

FIG. 2 is a graphic illustration of elements displayed within a graphical user interface illustrates an implementation of the process or system of FIG. 1.

FIG. 3 is a graphic illustration of elements displayed within a graphical user interface illustrates an implementation of the process or system of FIG. 1.

FIG. 4 depicts a computer device according to the present invention.

### DETAILED DESCRIPTION

FIG. 1 illustrates a method for the automatic identification and execution of investment opportunities in entities associated with graphic image subject matter. At 102, in response to a user selection of a graphic element that is displayed within a graphical user interface (GUI) display in circuit communication with a processor, the processor (for example, via executing optical image recognition software application program instructions stored on a computer-readable storage medium via a computer readable memory) identifies one or more corporate entities that is associated with the graphic element or a component of the graphic element, and that is associated with an opportunity for investment by the user in said corporate entity/entities.

At 104 the processor generates and displays one or more selectable investment icons on the GUI display that are each associated with separate ones of the entities.

At 106, in response to a selection of one of the investment icons by the user (via a GUI routine, spoken command translated by voice applications, etc.), the processor displays one or more selectable investment execution graphic elements that each describes conditions of an offer for investment in one of the corporate entities that is associated with the selected investment icon. Illustrative but not exhaustive examples include term bullet items, graphic text balloons, buttons, hyperlinks, or other selectable graphic elements that comprise textual term information, as well as audio presentation that recite the terms in a language of the user's choice, and still others will be apparent to one skilled in the art. Illustrative but not exhaustive examples of selection at 106 include scrolling over the item in the image, which may prompt display of ticker information related to stocks related to that particular item.

At 108, in response to a selection of one of the selectable investment execution graphic element by the user, the processer automatically executes the offer for investment in the corporate entity/entities associated with the selected investment icon opportunity, pursuant to the conditions described by the selected investment execution graphic element, thereby acquiring an investment for the user in said associated corporate entity/entities. For example, the users may be thereby linked directly to a broker associated with an account of the user, or as specified by the conditions described by the selected investment execution graphic element, or to a broker within a Social Media Network (SMN) of the user, or be directed to a top seller related to that particular stock and/or product, etc. If the user has an account, they can access their investment account after entering a password, wherein a broker related to their account may then be contacted and instructed to make an executable investment, using current account information or other designated information as applicable.

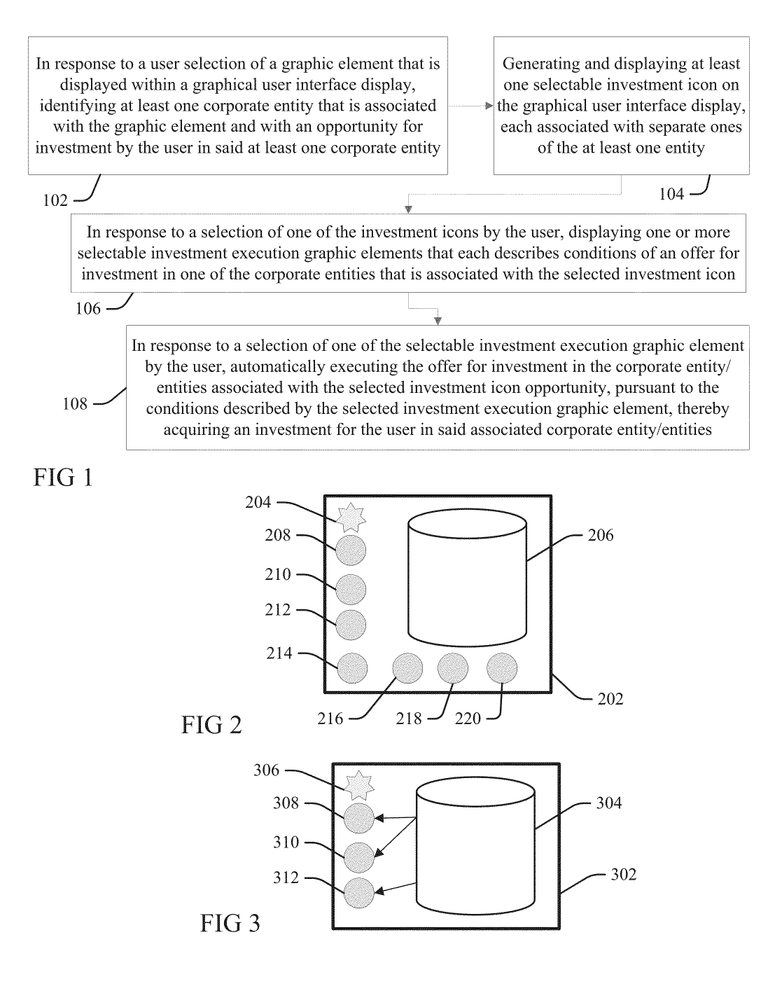

FIG. 2 is a graphic illustration of elements displayed within a graphical user interface 202 according to an implementation of the process or system of FIG. 1. In this example the selectable graphic element 206 is a pair of audio headphones. The image 206 may be acquired via a variety of sources, for example PINTEREST™, FACEBOOK™, INSTAGRAM™, PIXEL™, SNAPCHAT™, FLICKER™, TWITTER™, and still other sources will be apparent to one skilled in the art

Selection of the audio headphones graphic element 206 (at 102) results in identification and display of a number of selectable investment icons (at 104) that are each associated with separate entities: a production icon 208 associated with the maker of the headphones; a design icon 210 associated with the designer of the headphones; a supplier icon 212 associated with a company that supplies constituent components or raw materials used in creation of the headphones; a manufacturer icon 214 associated with a company that manufacturers constituent components of, or the entirety of the assembly of, the headphones; a vendor icon 216 associated with a company that sells or distributes the headphones at a retail or wholesale level; still others will be apparent to one skilled in the art.

An currency icon 218 allows the user to specify the currency or account to be used to defined any investment offer terms (displayed at 106) in response to selection of one of the selectable investment icons 208-210-212-214-216: for example, U.S. dollars, BITCOIN™, etc.

A donation icon 220 allows the user to donate a portion of their purchase, or to donate an additional amount (percentage, dollar amount, etc.), to a charity, which may be specified by user, or randomly selected, etc.

In some examples selection of an “Invest” icon 204 via a GUI routine triggers a communication to social media contacts (“friends”) to advise them of the offers for investment displayed via the selectable investment icons 208-210-212-214-216, or only those selected by the user. This enables the “sharing” of the offers to social contacts, to advise friends of recommended opportunities, thereby encouraging additional purchases of the offers through social networks.

FIG. 3 illustrates exemplary graphic illustrations of selectable investment execution graphic elements generated in response to a selection of investment icons by the user (at 106) displayed within another graphical user interface display 302 according to an implementation of the process or system of FIG. 1. In this example the selectable graphic element 304 is an athletic shoe. Graphic element 306 conveys the company name of the maker or supplier of the shoe itself, and the terms under which an investment may be purchased in this company. Graphic element 308 conveys the company name of the supplier of the nylon or cotton material, or manufacturer of this component, for the upper portion of the shoe (indicated by the arrow link), and investment terms. Graphic element 310 conveys the company name of the supplier of leather material, or manufacturer of this component, for the upper portion of the shoe. Graphic element 312 conveys the company name of the manufacturer of the rubber sole for the shoe.

The terms for investment conveyed by the graphic elements 306-308-310-312 may be expressed within the respective graphics or the user may chose to simplify the images and omit the terms from the graphic (pre-agreeing to accept the terms via selection of the graphics in a user agreement). Examples of the executable offer information include publicly traded stock symbols and the national exchanges offered upon, and the current trading prices; a mutual fund that holds shares in a company and is available for purchase by the user, and its current trading price; a hedge fund that owns a percentage of a company through private financing, wherein the company does not yet offer publicly traded shares, along with terms for purchasing an interest in the hedge fund; or similar information with respect to a subsidiary or parent company of the companies identified by the graphics that offer direct investment option when said identified companies do not provide direct investment opportunities. Still other examples will be apparent to one skilled in the art.

It will be understood that GUI displays may present multiple individual graphic images amenable for processing via the system of FIG. 1. The user may target individual items from selection, selectively triggering generation of the selectable investment icons (at 102-104) and selectable investment execution graphic elements (at 106) as desired, or as selectively driven by a service provider (for example, in exchange for fees).

Aspects thus transform image presentment via the internet, wherein image provider companies (for example, PINTEREST™, etc.) can now help public companies sell shares of stock to their users, and in consideration collect a percentage of the transaction or other fee. Opportunities quickly come alive and are presented as ready for automatic investment, via the user's trusted broker or brokerage account, or other default or specified or selected broker.

User are not limited to investments in the product of maker or seller thereof, but their opportunities are automatically expanded to encompass component manufacturers, associated supply chain vendors, component materials producers, chrome platers, engineering wiring and other component technology enterprises, component designers, and thereby the makers and associates of future, related products indirectly, in advance.

With the swipe of a finger on an INSTAGRAM™ picture within a GUI display, aspects enable a user to tap into the stock market and automatically realize investment opportunities associated with the product identified in the picture. The user can invest in companies he or she supports as a user or consumer, indirectly or directly owning a share of materials and retailers, etc., connected to the product, supported designers thereof as private investors.

Thus, the user may encounter the image of the shoe 304 while shopping on-line for shoes and browsing images of individual shoes. Triggering the process of FIG. 1 while viewing the shoe 304, the user finds out via information display within graphic element 306 the current price for stock in the company making the shoe is US$98.00, and within 312 that the price for publicly traded stock in the company that manufactures the rubber sole on this shoe is selling at US$5.00 per share. The user decides to buy five shares in the maker of the shoe, and one hundred shares in the rubber sole manufacturer. Thus, aspects of the present invention quickly and automatically expand opportunities and portfolio breadth for a user.

Consumers can easily and simply grow their investment portfolios and wealth during simple, every day internet browsing and surfing activities via aspects of the present invention. Advertising images (optionally limited to those from participating or fee-paying companies) can be browsed, paused and scanned for possible investment offers automatically executable via the process of FIG. 1.

In contrast to prior art presentments of direct consumer investing choices that are driven by analysis and recommendations provided by broker services, participation in stock indexes and the holdings of mutual funds, and personal awareness of goods and services created by news stories, advertising, personal consumer behavior and the like, aspects of the present invention automatically identify many small entity investment opportunities, ones that are only discoverable under prior art techniques upon expending large amounts of time and effort in research, including via arcane and hard to find sources. Aspects quickly identify and notify users of opportunities to identify and trade in investments in the many lesser-known companies that participate (profitably) in the same business activities with the larger, known and brand name entities, that the individual would miss under prior art techniques. Stocks shares may often be acquired in solid but lesser known entities at lower trading prices relative to their value from participating in the same endeavors as the larger, well-known companies, since demand from the public for the unknown or lesser known smaller company tends to be lower, in proportion to public awareness of such smaller, more obscure entities. Thus, aspects automatically and quickly generate and present better profit opportunities to a user, without any research effort by the user beyond selecting a graphic symbol or other element representing the company through a GUI routine.

Media and medial producers (for example, music videos, on-line video streaming services, television, etc.) are enabled by aspects of the present invention deployed on Smart TV's, mobile phones, computers, etc., to assist viewers in not only identifying products presented in graphic images for retail purchase, but in investing in the products, or the materials used to make the product, the supply chain entities associated with the product, etc. Stocks related to the images, tags related to stocks, symbols related to stocks, brokers related to those stocks, companies related to those stocks, prices related to those stocks, statistics related to those stocks, and other connected properties related to those stocks, are quickly and automatically present to the user, in connection with websites that allows users to click any image and invest in its company, material manufactures, vendors, and much more.

Users can be linked directly to broker within their SMN (Social Media Network) or be directed to the top seller related to that particular stock and/or product.

One scroll over any item in the image may trigger a display of ticker information related to stocks related to that particular item.

Investment brokers may use aspects of the present invention as a marketing tool to connect with more clients. Investment companies can add their stock ticker to relevant products for display to users, increasing their sales and productivity. Product manufactures can increase their visual presence before the public, and increase their funding via direct stock sales. Vendors can increase marketing visibility and profits.

Users are given the chance to not only indulge as consumers, but more importantly to invest in startups and existing companies. This allows more Warren Buffets to exist in the world, and will help teenagers and parents collaborate on investing projects based on what items they usually spend their money on, or invest in this week's trending photograph.

Aspects not only enable users to invest in the entities associated with still images, they may also pause, record and create still images from your streaming and broadcast movies, TV shows, videos, and invest in clothing, jewelry, meals, food and other products visible within the streaming and broadcast images. The road to investing is limited only by the capability of image tagging and recognition software and associated applications in identifying products within the images (at 102).

For example, clicking on an image of shoes of a favorite actor on the red carpet or other live-action scene may trigger identification of the shoes at 102, and an investing opportunity in the shoes or components, vendors thereof, etc, as described above. A user may also thereby invest in makers and suppliers of ingredients of a favorite cake or cake recipe, in the media company or paper printer or manufacturer that makes a favorite publication, a bottling company that makes your a bottled water, a manufacturer of the worlds' bestselling headphones, or in the material manufacturer that makes the clothes of a favorite TV shows' actor/actress.

Aspects of the present invention help the economy by expanding the reach of the investment market into new technologies and social media platforms, where young investors could utilize their social platforms to invest in the products, commercials, TV shows, ads, fashion items and other materials that they see in images, and to suggest similar investments to their social network contacts. Marketing and advertising structures are enabled to help the average person become a global investor. The purchase power that drives the economy can now be the investing power that changes the investment paradigm, forever.

Aspects of the present invention include systems, methods and computer program products that implement the aspects described above. A computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

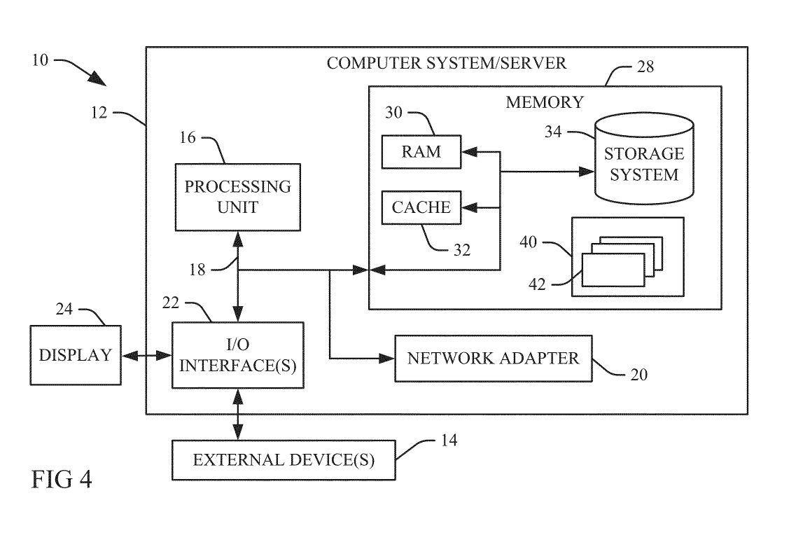

Referring now to FIG. 4, a programmable device 12 is operational with numerous other computing system environments or configurations. Examples of well-known computing systems, environments, and/or configurations that may be suitable for use with programmable device 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Programmable device 12 may be described in the general context of computer system-executable instructions, such as program modules, being executed by a computer system. Generally, program modules may include routines, programs, objects, components, logic, data structures, and so on that perform particular tasks or implement particular abstract data types. Programmable device 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, a special purpose programmable device 12 according to the present invention is a computer system/server device structure located within a cloud computing node 10. The components of the programmable device 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The programmable device 12 typically includes a variety of computer system readable media. Such media may be any available media that is accessible by the programmable device 12, and include both volatile and non-volatile media, removable and non-removable media.

System memory 28 can include computer system readable media in the form of volatile memory, such as random access memory (RAM) 30 and/or cache memory 32. Programmable device 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of a non-limiting example, as well as an operating system, one or more application programs, other program modules, and program data. Each of the operating systems, one or more application programs, other program modules, and program data or some combination thereof, may include an implementation of a networking environment. Program modules 42 generally carry out the functions and/or methodologies of embodiments of the invention as described herein.

Programmable device 12 may also communicate with one or more external devices 14 such as a keyboard, a pointing device, a display 24, etc.; one or more devices that enable a user to interact with programmable device 12; and/or any devices (e.g., network card, modem, etc.) that enable programmable device 12 to communicate with one or more other computing devices. Such communication can occur via Input/Output (I/O) interfaces 22. Still yet, programmable device 12 can communicate with one or more networks, such as a local area network (LAN), a general wide area network (WAN), and/or a public network (e.g., the Internet) via network adapter 20. As depicted, network adapter 20 communicates with the other components of programmable device 12 via bus 18. It should be understood that although not shown, other hardware and/or software components could be used in conjunction with programmable device 12. Examples include, but are not limited to: microcode, device drivers, redundant processing units, and external disk drive arrays, RAID systems, tape drives, and data archival storage systems, etc.

In one aspect, a service provider may perform process steps of the invention on a subscription, advertising, and/or fee basis. That is, a service provider could offer to integrate computer-readable program code into the programmable device 12 to enable the programmable device 12 to perform the methods, systems and processes discussed above with respect to the Figures file herewith. The service provider can create, maintain, and support, etc., a computer infrastructure, such as the programmable device 12, bus 18, or parts thereof, to perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the programmable device 12, from a tangible computer-readable medium device 34; (2) adding one or more computing devices to the computer infrastructure 10; and (3) incorporating and/or modifying one or more existing systems 12 of the computer infrastructure 10 to enable the computer infrastructure 10 to perform process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for the automatic identification and execution of investment opportunities in entities associated with graphic image subject matter, the method comprising executing on a processor the steps of:
in response to a user selection of a graphic element that is displayed within a graphical user interface display in circuit communication with the processor, identifying at least one corporate entity that is associated with the graphic element and with an opportunity for investment by the user in said at least one corporate entity;
generating and displaying at least one selectable investment icon on the graphical user interface display, wherein each of the at least one selectable investment icon is associated with separate ones of the at least one entity;
in response to a selection of one of the at least one selectable investment icon by the user, displaying at least one selectable investment execution graphic element, wherein each of the at least one selectable investment execution graphic element describes conditions of an offer for investment in an associated one of the at least one corporate entity that is associated with the graphic element and with the opportunity for investment by the user in said at least one corporate entity; and
in response to a selection of one of the at least one selectable investment icon by the user, automatically executing the offer for investment in the associated one of the at least one corporate entity pursuant to the described conditions, thereby acquiring an investment in the associated one of the at least one corporate entity for the user.

2. The method of claim 1, further comprising:
integrating computer-readable program code into a computer system comprising the processor, a computer readable memory in circuit communication with the processor, and a computer readable storage medium in circuit communication with the processor; and
wherein the processor executes program code instructions stored on the computer-readable storage medium via the computer readable memory and thereby performs the steps of identifying the at least one corporate entity associated with the graphic element and with the opportunity for investment in response to the user selection of the graphic element displayed within the graphical user interface display, generating and displaying the at least one selectable investment icon on the graphical user interface display, displaying the at least one selectable investment execution graphic element in response to the selection of one of the at least one selectable investment icon by the user, and automatically executing the offer for investment in the associated one of the at least one corporate entity pursuant to the described conditions, thereby acquiring an investment in the associated one of the at least one corporate entity for the user, in response to the selection of one of the at least one selectable investment icon by the user.

3. The method of claim 1, wherein the at least one selectable investment execution graphic element is a term bullet item, a graphic text balloon, button, hyperlink, other selectable graphic element that comprises textual term information, or an audio presentation that recite the terms to the user

4. The method of claim 1, wherein the selection by the user of the at least one selectable investment execution graphic element comprises the user scrolling over the item in the image, wherein the scrolling prompts display of ticker information related to stocks related to the scrolled over item.

5. The method of claim 1, wherein the step of acquiring the investment in the associated one of the at least one corporate entity for the user comprises directly executing a trade through a broker associated with an account of the user.

6. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
in response to a user selection of a graphic element that is displayed within a graphical user interface display in circuit communication with the processor, identifies at least one corporate entity that is associated with the graphic element and with an opportunity for investment by the user in said at least one corporate entity;
generates and displays at least one selectable investment icon on the graphical user interface display, wherein each of the at least one selectable investment icon is associated with separate ones of the at least one entity;
in response to a selection of one of the at least one selectable investment icon by the user, displays at least one selectable investment execution graphic element, wherein each of the at least one selectable investment execution graphic element describes conditions of an offer for investment in an associated one of the at least one corporate entity that is associated with the graphic element and with the opportunity for investment by the user in said at least one corporate entity; and
in response to a selection of one of the at least one selectable investment icon by the user, automatically executes the offer for investment in the associated one of the at least one corporate entity pursuant to the described conditions, thereby acquiring an investment in the associated one of the at least one corporate entity for the user.

7. A computer program product for the automatic identification and execution of investment opportunities in entities associated with graphic image subject matter, the computer program product comprising:
a computer readable hardware storage device having computer readable program code embodied therewith, wherein the computer readable hardware storage device is not a transitory signal per se, the computer readable program code comprising instructions for execution by a processor that cause the processor to:
in response to a user selection of a graphic element that is displayed within a graphical user interface display in circuit communication with the processor, identify at least one corporate entity that is associated with the graphic element and with an opportunity for investment by the user in said at least one corporate entity;
generate and displays at least one selectable investment icon on the graphical user interface display, wherein each of the at least one selectable investment icon is associated with separate ones of the at least one entity;
in response to a selection of one of the at least one selectable investment icon by the user, display at least one selectable investment execution graphic element, wherein each of the at least one selectable investment execution graphic element describes conditions of an offer for investment in an associated one of the at least one corporate entity that is associated with the graphic element and with the opportunity for investment by the user in said at least one corporate entity; and
in response to a selection of one of the at least one selectable investment icon by the user, automatically execute the offer for investment in the associated one of the at least one corporate entity pursuant to the described conditions, thereby acquiring an investment in the associated one of the at least one corporate entity for the user.
